(19) United States
(12) Patent Application Publication
(10) Pub. No.: US 2007/0068683 A1
(43) Pub. Date: Mar. 29, 2007

(54) Manually activated, portable fire-extinguishing aerosol generator

(75) Inventor: Rudy M. Pavesi, Old Tappan, NJ (US)

Correspondence Address: SCHWEGMAN, LUNDBERG, WOESSNER & KLUTH, P.A., P.O. BOX 2938, MINNEAPOLIS, MN, 55402, US

(73) Assignee: FIREAWAY LLC, Minnetonka, MN (US)

(21) Appl. No.: 11/234,733

(22) Filed: Sep. 23, 2005

(51) Int. Cl. A62C 2/00; A62C 11/00; A62C 13/22

(52) U.S. Cl. 169/46; 169/30; 169/84

(57) ABSTRACT

Manually activated, portable aerosol fire extinguisher includes a casing having discharge ports, an arrangement for generating fire suppression agent which is discharged through the discharge ports, and a manual activation system which enables manual activation of the generating arrangement at a safe location a distance from the fire. The activation system includes a firing pin which causes ignition of igniter material upon contact therewith (resulting in generation of the fire suppression agent), a handle which normally prevents the firing pin from contacting the igniter material and a manually releasable pull pin arranged to maintain the handle in a position preventing the firing pin from contacting the igniter material. Upon release of the pull pin, the handle is urged out of this position with the result that the firing pin contacts the igniter material, thereby causing generation of the fire suppression agent.

### FIELD OF THE INVENTION

The present invention relates generally to a fire-extinguishing aerosol generator and more specifically to a manually activated, portable fire-extinguishing aerosol generator designed to be thrown or otherwise introduced from a relatively safe location into a fire in an enclosed volume and discharge a fire suppression agent once in the enclosed volume to thereby extinguish the fire.

The present invention also relates to a method for extinguishing a fire in an enclosed volume using a portable aerosol generator.

### BACKGROUND OF THE INVENTION

Self-contained aerosol generators are often used to extinguish fires in enclosed volumes. The generators are usually mounted within the boundaries defining the enclosed volume and automatically activated electronically by means of remote sensing devices coupled to an electronic releasing panel which sends a signal activating the aerosol generator upon the sensing of a fire. Upon activation, the generators generate a quantity of an aerosol fire suppression agent which disperses into the enclosed volume and chemically interferes with fire propagating radicals thereby interrupting the fire reaction.

A conventional aerosol generator includes a casing which is mounted to a wall or other structure by means of a fixed bracket and includes discharge ports. To generate the aerosol fire suppression agent, a combustible aerosol-forming compound is arranged in the casing. The internal space downstream of the aerosol-forming compound, i.e., in the direction of discharge of the fire suppression agent from the casing, defines a combustion chamber which may be followed by structural elements which oxidize and/or cool the aerosol as it is discharged from the unit. Igniter material is arranged in connection with the aerosol-forming compound to cause combustion thereof and is ignited by receipt of an electronic signal from a releasing panel initiated by a remotely located sensor upon detection of a fire in the enclosed volume. Upon ignition of the igniter material, combustion of the aerosol-forming compound occurs resulting in dispersion of the aerosol fire suppression agent through the discharge ports in a manner known to those skilled in the art.

Aerosol generators are often incorporated into a system which includes fire-sensing devices spaced around the enclosed volume and a releasing panel which monitors the integrity of the system and activates the generators upon notification of a fire by means of a signal received from one or more of the sensing device. Instead of remote fire-sensing devices, some aerosol generators include a thermal sensor arranged directly on the generator, however, these are used primarily for very small volumes such as within an electronic cabinet.

A drawback of fixedly mounting such aerosol generators is that they cannot be easily moved in a timely fashion to extinguish a fire from a different location than the mounting location. Thus, if an aerosol generator is arranged in one room of a facility and a fire is present in another room, the aerosol generator cannot be readily removed from the room without the fire, moved to the room with the fire and activated therein. In fact, removal of an aerosol generator from its mounting location for use at another location is not even worthwhile because most are electronically activated and therefore would not activate in a safe or timely manner if thrown into a fire. As such, conventional aerosol generators are not considered portable apparatus.

However, a portable aerosol generator is known, namely an aerosol fire extinguisher designated FP-1000M and sold by Celanova Ltd. under the tradename FirePro. This aerosol generator is manually activated by pulling a safety pin which results in immediate combustion of an aerosol-forming compound. This aerosol generator is susceptible to causing injury to users since it does not appear to include a handle or other mechanism which allows for a time delay between pulling the safety pin and combustion of the aerosol-forming compound.

Accordingly, it would be desirable to provide a portable aerosol generator which includes such a time delay mechanism.

### OBJECTS AND SUMMARY OF THE INVENTION

It is an object of the present invention to provide a new and improved portable fire extinguisher, namely, a portable aerosol generator.

It is another object of the present invention to provide a new portable fire extinguisher which can be easily moved to a desired activation location, i.e., an enclosed volume with a fire therein, and manually activated when at that location.

It is yet another object of the present invention to provide a new portable fire extinguisher which can be safely thrown or otherwise introduced into a fire in an enclosed volume and activated upon being thrown or introduced to thereby generate a fire suppression agent which extinguishes the fire.

It is still another object of the present invention to provide a new method for extinguishing a fire using a portable aerosol generator.

In order to achieve these objects and others, an apparatus for extinguishing a fire in accordance with the invention includes a casing having at least one discharge port at one end region thereof, an arrangement of one or more materials in the casing capable of generating an aerosol fire suppression agent which is discharged through the discharge port(s), and a manual activation system which enables manual activation of the fire suppression agent generating arrangement at a relatively safe location and distance from the fire. The casing can thus be thrown or otherwise introduced into the fire upon the manual activation of the generating arrangement.

The materials for generating the fire suppression agent usually include an ignitable and combustible aerosol-forming compound, an optional oxidation material arranged at a distance therefrom to define a combustion chamber between the aerosol-forming compound and the oxidation material in which combustion of the aerosol-forming compound occurs, and optional cooling material arranged adjacent the discharge port(s). The generating arrangement also includes igniter material arranged in connection with the aerosol-forming compound and which is ignited by the manual activation system to cause ignition and combustion of the aerosol-forming compound.

The manual activation system includes a firing pin which causes ignition of the igniter material upon contact therewith, a handle or other restraining member which normally restrains or prevents the firing pin from contacting the igniter material and a manually releasable pull pin arranged to maintain the handle in a position in which the firing pin is prevented from contacting the igniter material. Upon release of the pull pin, the handle can be urged out of a position in which it prevents contact between the firing pin and the igniter material, with the result that the firing pin can brought into contact with the igniter material, thereby causing generation of the fire suppression agent.

Movement of the firing pin from its restrained position into its contact position may be caused by a spring or other biasing mechanism which biases the firing pin against the handle and into contact with the igniter material. Thus, upon release of the pull pin, the spring causes the firing pin to displace the handle and continue its movement until it impacts the igniter material.

The pull pin and handle may be designed to cooperate such that the pull pin can be released only when a part of the handle is urged against the casing, to prevent inadvertent release of the pull pin resulting in unwanted activation of the apparatus.

A time delay between an initial activation stage of the manual activation system, i.e., when the pull pin is released, and subsequent activation of the fire suppression agent generation arrangement, i.e., ignition and combustion of the aerosol-forming compound, is provided to allow for the time needed between the time of actuation and introduction of the apparatus into a fire and the time for a person who actuates the apparatus to get to a safe distance from the fire. This time delay may be integrated or incorporated into the igniter material.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a perspective view of a manually activated, portable fire-extinguishing aerosol generator in accordance with the invention.

FIG. 2 is a cross-sectional view of the aerosol generator shown in FIG. 1.

FIG. 3 is an alternative cross-sectional view of the aerosol generator shown in FIG. 1.

FIG. 4 is an enlarged view of the upper portion of the aerosol generator shown in FIG. 1 with the firing pin in an activation position.

### DETAILED DESCRIPTION OF THE INVENTION

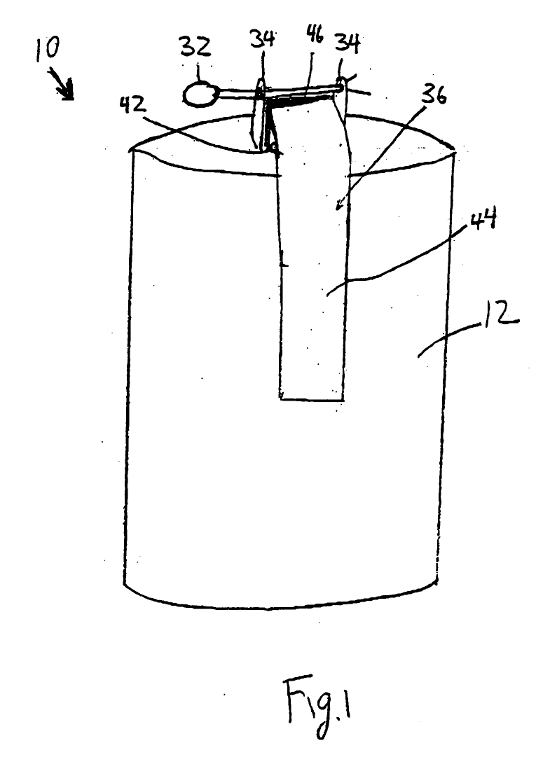

Referring to the accompanying drawings wherein like reference numbers refer to the same or similar objects, FIGS. 1-4 show a manually activated, portable aerosol fire extinguisher in accordance with the invention which is designated generally as 10 and comprises a substantially cylindrical casing 12 having discharge ports 14 at one end. Thermal insulation may be provided in the walls of the casing 12.

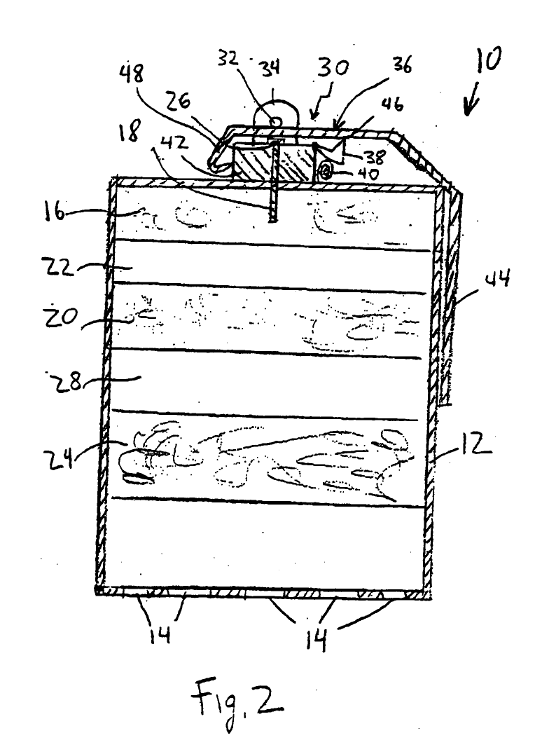

In casing 12, one or more materials capable of generating aerosol fire suppression agent to be discharged through the discharge ports 14 are provided. For example, as shown in FIG. 2, the casing 12 includes an aerosol-forming compound 16 arranged at the end opposite the discharge ports 14, a block of igniter material 18 which extends partially into the aerosol-forming compound 16, a block of oxidation material 20 arranged at a distance from the aerosol-forming compound 16 to define a combustion chamber 22 therebetween and a block of cooling material 24 arranged adjacent the discharge ports 14. Igniter material 18 includes a primer 26 at its upper end. A reaction chamber 28 is defined between the block of oxidation material 20 and the block of cooling material 24.

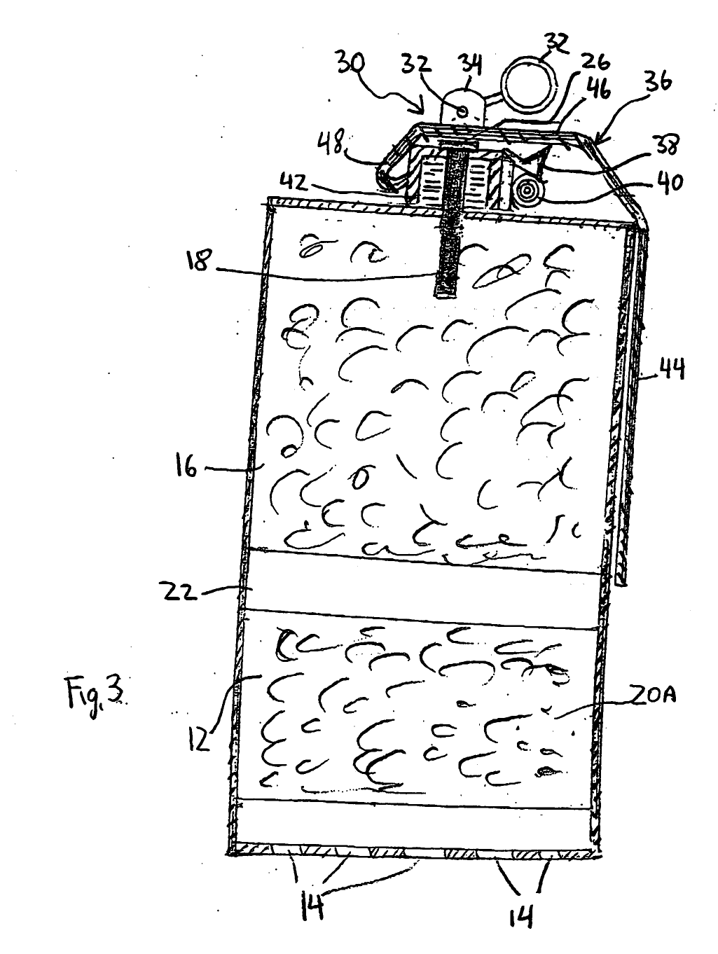

As shown in FIG. 3, a single block of oxidation material and/or cooling material 20A can be used instead of a block of oxidation material 20 and a separate block of cooling material 22 as shown in FIG. 2.

The manner in which an aerosol fire suppression agent is generated upon ignition of the igniter material 18 and discharged through the discharge ports 14 is known in the art.

Casing 12 can be constructed with a variety of different sizes and fire suppression agent generating capacities, with the attendant different quantities of aerosol-forming compound 16, igniter material 18, oxidation material 20 and cooling material 24.

Possible ignitable and combustible aerosol-forming compounds for use in the invention include those described in U.S. Pat. Nos. 5,831,209, 6,042,664, 6,264,772 and 6,689,285 (all of which are assigned to R-Amtech International, Inc. and incorporated by reference herein).

In accordance with the invention, the aerosol fire extinguisher 10 includes a manual activation system 30 which requires a manual effort in order to cause ignition of the igniter material 18 resulting in generation of the fire suppression agent and its discharge through the discharge ports 14. By contrast, in prior art aerosol generators, ignition of the igniter material is performed automatically upon detection of a fire without any manual effort.

Specifically, the manual activation system 30 includes a manually releasable pull pin 32 which is removably engaged with supports 34 arranged on the outer surface of the casing 12, a handle 36 which is maintained in a position on the casing 12 by the engagement of the pull pin 32 with the supports 34, and a firing pin 38 which is biased against the handle 36 by a spring 40. Pull pin 32 includes a pull ring and a safety cotter pin extending through the supports 34. The firing pin 38 is mounted on a mounting projection 42 on the axial wall of the casing 12 and biased to pivot about the mounting projection 42 into contact with the primer 26 of the igniter material 18. The impact of the firing pin 38 with the primer 26 causes ignition thereof and then ignition of the igniter material 18. However, handle 36 restrains firing pin 38 in that it prevents firing pin 38 from contacting the primer 26 when handle 36 is held in the position on the casing 12 by engagement of the pull pin 32 with the supports 34.

Handle 36 has a first part 44 arranged alongside a lateral wall of the casing 12, a second part 46 arranged above an axial wall of the casing 12 and over the mounting projection 42, and a third hook part 48 which engages with the mounting projection 42 (see FIG. 2). Instead of handle 36, other restraining members which restrain the firing pin 38 when the pull pin 32 is attached to the casing 12 while allowing pivotal movement of the firing pin 38 when the pull pin 32 is detached from the casing 12 can be provided.

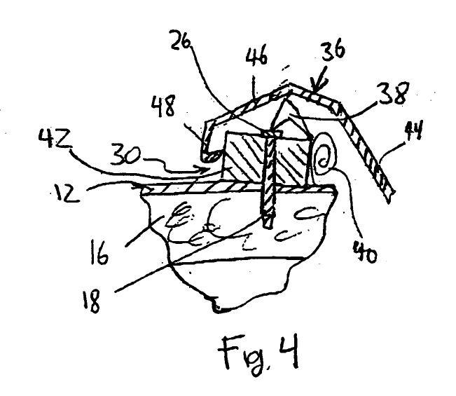

In use, upon removal of the pull pin 32 from engagement with the supports 34, the handle 36 can be urged out of its position restraining firing pin 38. The biasing force provided by spring 40 causes the firing pin 38 to pivot about the mounting projection 42 thereby forcing the handle 36 away from the casing 12 and out of a position in which it is preventing the firing pin 38 from contacting the primer 26. Upon continued pivoting movement, the firing pin 38 then impacts the primer 26 causing ignition of the igniter material 18 (see FIG. 4) which in turn causes combustion of the aerosol-forming compound 16 resulting in generation of the fire suppression agent and its discharge through discharge ports 14.

Thus, to extinguish a fire in an enclosed volume using aerosol fire extinguisher 10, the user would carry the aerosol fire extinguisher 10 to a site in close proximity to the enclosed volume, identify or create an access opening in or to the enclosed volume, e.g., open a door or window leading to the enclosed volume, remove the pull pin 32 from engagement with the supports 34 while holding the first part 44 of the handle 36 against the casing 12, and then introduce the fire extinguisher 10 into the enclosed volume, e.g., throw the fire extinguisher into the fire. If possible, the access to the enclosed volume is blocked, i.e., close the door or window from which the fire extinguisher 10 was thrown. As the fire extinguisher is in its trajectory into the enclosed volume, the spring 40 causes the firing pin 38 to urge the handle 36 away from its position on the casing 12 (which is possible since the user is no longer maintaining the handle 36 against the casing 12) and urges the firing pin 38 to impact the primer 26 causing ignition of the igniter material 18. Ignition of the igniter material 18 causes combustion of the combustion material 16 leading to generation of the fire suppression agent and its discharge through the discharge ports 14. The casing 12 remains intact after all of the fire suppression agent has been generated and discharged through the discharge port 14.

A time delay between the release of the handle 36 and discharge of the fire suppression agent may be provided by appropriate design and construction of, for example, the primer 26, the igniter material 18 and/or the aerosol-forming compound 16. Such a time delay is important to allow for the time needed between the time of actuation and introduction of the aerosol fire extinguisher 10 into the fire and time for the person who actuates the fire extinguisher 10 to get to a safe distance from the fire. The manner in which a time delay is provided via construction or composition of the igniter material 18 is known in the military grenade field.

The combination of the igniter material 18, primer 26, pull pin 32 and handle 36 can be considered the fuse of the aerosol fire extinguisher. An alternative fuse for use in the invention incorporates an additional safety mechanism to ensure adequate time to safely release the aerosol fire extinguisher 10, such as a sliding safety latch which must be moved prior to releasing the handle 36.

The pull pin 32 and handle 36 may be constructed to cooperate such that the pull pin 32 can be released only when the handle 36 is urged against the casing 12. This would prevent inadvertent release of the pull pin 32 and thus avoid unwanted activation of the aerosol fire extinguisher 10. Other variations in the manual activation system 30 are envisioned, for example, variations in the construction of the pull pin 32, handle 36, firing pin 38 and spring 40, and such variations may be derived from conventional grenade-type devices, such as munitions.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention. For example, although the described embodiments include at least one additional block of oxidation material and/or cooling material downstream of the aerosol-forming compound, it is also possible to eliminate both types of materials and cool the aerosol-forming compound by misdirection of the aerosol through an exit path causing a heat exchange.

1. An apparatus for extinguishing a fire, comprising:
an elongate casing having at least one discharge port at one end region;
generating means arranged in said casing for generating an aerosol fire suppression agent and discharging the aerosol fire suppression agent through said at least one discharge port; and
manual activation means for enabling manual activation of said generating means at a relatively safe location a distance from the fire whereby said casing is introducible into the fire upon the manual activation of said generating means.

2. The apparatus of claim 1, wherein said activation means includes a time delay between an initial activation stage of said activation means and subsequent activation of said generating means.

3. The apparatus of claim 1, wherein said generating means comprise an aerosol-forming compound and igniter material arranged in connection with said aerosol-forming compound such that ignition of said igniter material causes combustion of said aerosol-forming compound thereby initiating generation of the aerosol fire suppression agent, said manual activation means being arranged to ignite said igniter material.

4. The apparatus of claim 3, wherein said activation means comprise a firing pin which causes ignition of said igniter material upon contact therewith, restraining means for restraining said firing pin from contacting said igniter material and a manually releasable pull pin arranged to maintain said restraining means in a position in which said firing pin is prevented from contacting said igniter material, said pull pin being releasable to allow said restraining means to be urged out of said position such that said firing pin is then movable into contact with said igniter material.

5. The apparatus of claim 4, wherein said activation system further comprises biasing means for biasing said firing pin against said restraining means and into contact with said igniter material.

6. The apparatus of claim 5, wherein said biasing means comprise a spring.

7. The apparatus of claim 4, wherein said igniter material extends at least partially into said aerosol-forming compound.

8. The apparatus of claim 4, wherein said igniter material comprises a primer arranged at an end of said igniter material in a position to be contacted by said firing pin.

9. The apparatus of claim 4, further comprising a mounting projection arranged on said casing, said igniter material extending through said mounting projection and said firing pin being movably mounted to said mounting projection.

10. The apparatus of claim 4, wherein said restraining means comprise a handle having a first part arranged alongside a lateral wall of said casing and a second part arranged above an axial wall of said casing.

11. The apparatus of claim 1, wherein said generating means comprise:
an aerosol-forming compound;
oxidation material arranged at a distance from said aerosol-forming compound to define a combustion chamber between said aerosol-forming compound and said oxidation material; and
cooling material arranged adjacent said at least one discharge port.

12. The apparatus of claim 1, wherein said generating means comprise:
an aerosol-forming compound;
a single block of at least one of oxidation material and cooling material arranged at a distance from said aerosol-forming compound to define a combustion chamber between said aerosol-forming compound and said block.

13. An apparatus for extinguishing a fire, comprising:
an elongate casing having at least one discharge port at one end region and materials designed to generate aerosol fire suppression agent which is discharged through said at least one discharge port; and
a manual activation system arranged to initiate generation of the aerosol fire suppression agent by said materials at a relatively safe location a distance from the fire, said manual activation system including a manually releasable pull pin which allows generation of the aerosol fire suppression agent upon its release.

14. The apparatus of claim 13, wherein said materials include an aerosol-forming compound and igniter material arranged in connection with said aerosol-forming compound such that ignition of said igniter material causes combustion of said aerosol-forming compound thereby initiating generation of the aerosol fire suppression agent, said manual activation system being arranged to ignite said igniter material.

15. The apparatus of claim 14, wherein said activation system further comprises a firing pin which causes ignition of said igniter material upon contact therewith and a handle for restraining said firing pin from contacting said igniter material, said pull pin being arranged to maintain said handle in a position in which said firing pin is prevented from contacting said igniter material and being releasable to allow said handle to be urged out of said position such that said firing pin is then movable into contact with said igniter material.

16. The apparatus of claim 15, further comprising a spring arranged to bias said firing pin against said handle and into contact with said igniter material.

17. The apparatus of claim 13, wherein said activation system includes a time delay to delay generation of the fire suppression agent after release of said pull pin.

18. A method for extinguishing a fire, comprising:
arranging materials which generate aerosol fire suppression agent in an elongate casing having at least one discharge port at one end region through which the aerosol fire suppression agent is discharged from the casing, the materials including an aerosol-forming compound and igniter material in contact with the aerosol-forming compound;
biasing a firing pin into a position in which it contacts the igniter material to cause ignition thereof which in turns causes ignition and combustion of the aerosol-forming compound;
arranging a pull pin in a position in which it prevents contact between the firing pin and the igniter material;
in the presence of the fire, removing the pull pin from its position to thereby enable contact between the firing pin and the igniter material; and
introducing the casing into a fire to cause discharge of the aerosol fire suppression agent.

19. The method of claim 18, further comprising:
positioning a handle to prevent contact between the firing pin and the igniter material; and
positioning the pull pin to restrain the handle on the casing.

20. The method of claim 18, further comprising integrating a time delay into the igniter material to delay ignition and combustion of the aerosol-forming compound after removal of the pull pin from its position.
